(19) United States
(12) Patent Application Publication
(10) Pub. No.: US 2004/0214070 A1
(43) Pub. Date: Oct. 28, 2004

(54) Low sintering lanthanum ferrite materials for use as solid oxide fuel cell cathodes and oxygen reduction electrodes and other electrochemical devices

(76) Inventors: Steven P. Simner, Richland, WA (US); Jeffry W. Stevenson, Richland, WA (US)

Correspondence Address: Attn: Gregory B. Coy, Woodard, Emhardt, Moriarty, McNett & Henry LLP, Bank One Center/Tower, 111 Monument Circle, Suite 3700, Indianapolis, IN, 46204-5137, US

(21) Appl. No.: 10/426,063

(22) Filed: Apr. 28, 2003

(51) Int. Cl. H01M 8/12; H01M 4/86; H01M 4/88

(52) U.S. Cl. 429/40; 429/33; 502/101

(57) ABSTRACT

The present invention provides novel compositions that find advantageous use in making electrodes for electrochemical cells. Also provided are electrochemical devices that include active oxygen reduction electrodes, such as solid oxide fuel cells, sensors, pumps and the like. The compositions comprise a modified lanthanum ferrite perovskite material. The invention also provides novel methods for making and using the electrode compositions and solid oxide fuel cells and solid oxide fuel cell assemblies having cathodes comprising the compositions.

### GOVERNMENT RIGHTS

This invention was made with Government support under Contract Number DE-AC0676RLO1830 awarded by the U.S. Department of Energy. The Government has certain rights in the invention.

### BACKGROUND

The present invention relates-generally to the field of fuel cells and other electrochemical devices, and more particularly but not exclusively to electrochemical devices including subtly modified lanthanum strontium ferrite cathodes having an advantageous combination of features. Materials and devices in accordance with the invention find advantageous use in solid oxide electrolyte electrochemical devices such as, for example, solid oxide fuel cells, electrolyzers, electrochemical sensors and the like.

As a background to the invention, electrochemical devices based on solid oxide electrolytes have received, and continue to receive, significant attention. For example, solid state oxygen separation devices have received significant attention for the separation of pure oxygen from air. In addition, electrochemical fuel cell devices are believed to have significant potential for use as power sources. Fuel cell devices are known and used for the direct production of electricity from standard fuel materials including fossil fuels, hydrogen, and the like by converting chemical energy of a fuel into electrical energy. Fuel cells typically include a porous fuel electrode (also referred to as the “anode”), a porous air electrode (also referred to as the “cathode”), and a solid or liquid electrolyte therebetween. In operation, gaseous fuel materials are contacted, typically as a continuous stream, with the anode of the fuel cell system, while an oxidizing gas, for example air or oxygen, is allowed to pass in contact with the cathode of the system. Electrical energy is produced by electrochemical combination of the fuel with the oxidant. Because fuel cells convert the chemical energy of the fuel directly into electricity without the intermediate thermal and mechanical energy step, their efficiency can be substantially higher than that of conventional methods of power generation.

Solid oxide fuel cells (SOFCs) employing a dense ceramic electrolyte are currently considered as one of the most attractive technologies for electric power generation. In a typical SOFC, a solid electrolyte separates the porous metal-based anode from a porous metal or ceramic cathode. Due to its mechanical, electrical, chemical and thermal characteristics, yttria-stabilized zirconium oxide (YSZ) is currently the electrolyte material most commonly employed. At present, the anode in a typical SOFC is made of nickel-YSZ cermet, and the cathode is typically made of lanthanum manganites, lanthanum ferrites or lanthanum cobaltites. In such a fuel cell, an example of which is shown schematically in FIG. 1, the fuel flowing to the anode reacts with oxide ions to produce electrons and water. The oxygen reacts with the electrons on the cathode surface to form oxide ions that migrate through the electrolyte to the anode. The electrons flow from the anode through an external circuit and then to the cathode. The movement of oxygen ions through the electrolyte maintains overall electrical charge balance, and the flow of electrons in the external circuit provides useful power. Useful fuels for fuel cell power generation include, for example, hydrogen, carbon monoxide, methane and hydrazine.

Because each individual electrochemical cell made of a single anode, a single electrolyte, and a single cathode generates an open circuit voltage of about one volt and each cell is subject to electrode activation polarization losses, electrical resistance losses, and ion mobility resistant losses which reduce its output to even lower voltages at a useful current, a fuel cell assembly comprising a plurality of fuel cell units electrically connected to each other to produce the desired voltage or current is required to generate commercially useful quantities of power.

SOFCs typically operate at high temperatures, such as, for example, 650-1000° C. This allows flexibility in fuel choice and results in suitable fuel-to-electricity and thermal efficiencies; however, high temperatures impose stringent requirements on the materials selection for components of the fuel cell or fuel cell assembly. For example, it is well recognized that such high temperatures prevent the use of metallic materials in certain components and prevent the use of other materials that would otherwise be advantageous, but that are not stable at such temperatures.

Recent SOFC cathode development has focused on lanthanum strontium ferrite (LSF). While a substantial improvement over the older lanthanum strontium manganite in the 700° C. to 900° C. range, the performance of an SOFC would benefit from further improvements in the properties of the cathode over those exhibited by LSF.

High temperatures are typically experienced by portions of the fuel cell during fabrication. For example, it is common to form parts of a fuel cell from ceramics via a process which entails, among other things, high temperature sintering. For example sintering temperatures in the range of 1000-1400° C. are not uncommon, and such high temperature processing places a significant limitation upon the types of materials that can be used and the orientation of materials in a fuel cell. For example, a lanthanum strontium ferrite composition including about 20 mole % strontium A-site dopant, La_{0.8}Sr_{0.2}FeO₃ (referred to herein as “LSF-20”), is typically sintered at a temperature of about 1150° C. A problem that arises in the use of LSF-20, however, is that, when it is in contact with YSZ electrolyte at that temperature, zirconium cations migrate into, and are incorporated into, the LSF-20 perovskite structure, where they act as blocking sites to electron migration, and hence decreased electrical conductivity of the LSF-20 material. For this reason, a fuel cell design including a LSF-20 cathode and a YSZ electrolyte layer must also include a barrier layer between the cathode and the electrolyte to prevent zirconium migration. Fuel cells including these materials therefore are typically designed to include a ceria layer, i.e., Ce_{0.8}Sm₀₂O_{1.9} (SDC-20), between the cathode and the electrolyte. While a ceria interlayer is an effective barrier to prevent zirconium migration, its presence adds to the complexity, and therefore the cost, of fuel cell fabrication processes owing to the need for additional processing steps, and difficulties in achieving an acceptable ceria layer density. In addition, the ceria layer causes extra resistance in the fuel cell, which ultimately results in less than optimum power generation.

In view of the above background, it is apparent that there is a continuing need for further developments in the field of SOFC technology. In particular, there is a need for further advancement in the development of alternative cathode materials. The present invention addresses these needs, and further provides related benefits and advantages.

### SUMMARY OF THE INVENTION

Accordingly, it is one object of this invention to provide novel oxygen reduction electrode materials for solid oxide fuel cells and other electrochemical devices having an advantageous combination of features. In particular, inventive compositions feature relatively low sintering temperatures and good resistance to fouling when sintered adjacent a zirconium-containing compositions. It is another object of this invention to provide electrochemical devices with solid oxide electrolytes that include electrode materials provided by the present invention.

These and other objects are achieved by the present invention, which provides modified lanthanum ferrite electrodes suitable for use in solid oxide fuel cells and other electrochemical devices. The present invention also provides solid oxide fuel cells, solid oxide fuel cell assemblies and other electrochemical devices that include modified lanthanum ferrite materials provided by the present invention. While the actual nature of the invention covered herein can only be determined with reference to the claims appended hereto, certain forms of the invention that are characteristic of the embodiments disclosed herein are described briefly as follows.

In one form, the present invention provides a solid oxide fuel cell for electrochemically reacting a fuel gas with an oxidant gas to produce a DC output voltage. The solid oxide fuel cell includes a layer of ceramic ion conducting electrolyte defining first and second opposing surfaces, the electrolyte comprising a zirconium-containing material; a conductive anode positioned in contact with the first surface of the electrolyte layer; and a conductive cathode positioned in contact with the second surface of the electrolyte layer, the cathode comprising a modified lanthanum ferrite perovskite material. The modified lanthanum ferrite perovskite material is in direct contact with said zirconium-containing material. The fuel cell has a power density of at least about 1.0 W/cm² at 750° C. and 0.7V. In one preferred embodiment, copper is present in the perovskite material in an amount of from about 1 to about 5 atomic percent. In another embodiment, strontium is present as an A-site dopant in the perovskite material in an amount up to about 50 atomic percent. In yet another embodiment, the perovskite material comprises A-site deficiency of from about 0.9 to about 1.0. The perovskite material preferably has a sintering temperature of no greater than about 1100° C.

An example of a cathode perovskite composition provided by the invention is a composition having the formula:

La_{0.8} Sr_{0.2} Fe_{0.98} Cu_{0.02} O₃

An example of a cathode perovskite composition provided by the invention that has A-site deficiency is a composition having the formula:

(La_{0.8} Sr_{0.2})_{0.98} Fe_{0.98} CU_{0.02} O₃

In another form of the invention, there is provided a solid oxide fuel cell for electrochemically reacting a fuel gas with an oxidant gas to produce a DC output voltage. The solid oxide fuel cell includes a layer of ceramic ion conducting electrolyte defining first and second opposing surfaces; a conductive anode positioned adjacent the first surface of said electrolyte layer; and a conductive cathode positioned adjacent the second surface of said electrolyte layer. The cathode comprises a lanthanum ferrite perovskite material, and copper is present in the lanthanum ferrite perovskite material in an amount of from about 1 to about 5 atomic percent. The lanthanum ferrite perovskite material has a sintering temperature of no greater than about 1100° C. In one preferred embodiment, the lanthanum ferrite perovskite material is in direct contact with said electrolyte.

In another form of the invention, there is provided a solid oxide fuel cell assembly for electrochemically reacting a fuel gas with a flowing oxidant gas to produce a DC output voltage. The assembly includes a plurality of integral fuel cell units, each unit comprising a layer of ceramic ion conducting electrolyte disposed between a conductive anode layer and a conductive cathode layer. The electrolyte of at least one of said fuel cells comprises a zirconium-containing material, and the cathode layer of at least one of the fuel cells comprises a modified lanthanum ferrite composition that is in direct contact with the zirconium-containing material. At least one of the fuel cells has a power density of at least about 1.0 W/cm² at 750° C. and 0.7V.

In another form of the invention, there is provided a solid oxide fuel cell assembly for electrochemically reacting a fuel gas with a flowing oxidant gas to produce a DC output voltage, the assembly including a plurality of integral fuel cell units, each unit comprising a layer of ceramic ion conducting electrolyte disposed between a conductive anode layer and a conductive cathode layer; wherein the cathode layer of at least one of said fuel cells comprises a lanthanum ferrite composition; wherein copper is present in the lanthanum ferrite perovskite material in an amount of from about 1 to about 5 atomic percent; and wherein the lanthanum ferrite perovskite composition has a sintering temperature of no greater than about 1100° C. In one embodiment, the lanthanum ferrite composition is in direct contact with said electrolyte.

In another form of the invention a cathode for a solid oxide fuel cell is provided. The cathode comprises a modified lanthanum ferrite perovskite material including a member selected from the group consisting of copper, manganese and zinc in an amount of from about 1 to about 5 atomic percent. In one preferred embodiment, copper is present in the perovskite in an amount of from about 2 to about 3 atomic percent. In another embodiment, the material includes an A-site dopant selected from the group consisting of Mg, Ca, Sr, Ba, Pr, Nd, Sm and combinations thereof. In yet another embodiment, strontium is present as an A-site dopant in the material in an amount of from about 5 atomic percent to about 40 atomic percent and copper is present in the copper-substituted lanthanum ferrite material in an amount of from about 1 atomic percent to about 5 atomic percent. In still another embodiment, the material comprises A-site deficiency of from about 0.9 to about 1.0. The copper-substituted ferrite material can advantageously be in direct contact with an electrolyte layer comprising a zirconium-containing material. In one embodiment, the perovskite material has a sintering temperature of no greater than about 1100° C.

In another form of the invention, an oxygen reduction electrode for an electrochemical device is provided, the electrode comprising a modified lanthanum ferrite perovskite material including a member selected from the group consisting of copper, manganese and zinc in an amount of from about 1 to about 5 atomic percent. The electrochemical device in alternate aspects of the invention can be a solid oxide fuel cell, an electrolyzer, an electrochemical pump or an electrochemical sensor.

In yet another form of the invention, there is provided a method for producing electrical energy, comprising: (1) providing a solid oxide fuel cell, the solid oxide fuel cell including a layer of ceramic ion conducting electrolyte defining first and second opposing surfaces, the electrolyte comprising a zirconium-containing material; a conductive anode positioned at the first surface of the electrolyte layer; and a conductive cathode positioned at the second surface of the electrolyte layer, the cathode comprising a modified lanthanum ferrite perovskite material; wherein the modified lanthanum ferrite perovskite material is in direct contact with the zirconium-containing material; and wherein the fuel cell has a power density of at least about 1.0 W/cm² at 750° C. and 0.7V; (2) causing air or other oxidizing gas to flow in contact with the cathode layer; and (3) causing a fuel gas to flow in contact with the anode layer to provide electrical energy. In a preferred embodiment, copper is present in the material in an amount of from about 1 to about 5 atomic percent. In another embodiment, the material comprises A-site deficiency of from about 0.95 to about 0.99.

In another form of the invention, there is provided a method for making an oxygen reduction electrode for an electrochemical device comprising: (1) providing a green material comprising a modified lanthanum ferrite perovskite composition including a member selected from the group consisting of copper, manganese and zinc in an amount of from about 1 to about 5 atomic percent; (2) placing the green material in contact with an electrolyte layer; and (3) sintering the green material at a temperature of no greater than about 1100° C. In one preferred embodiment, the electrolyte layer is a zirconium-containing electrolyte layer; and the lanthanum ferrite composition is in direct contact with the zirconium-containing electrolye layer.

Further objects, features, advantages, benefits, and further aspects of the present invention will become apparent from the drawings and description contained herein.

### BRIEF DESCRIPTION OF THE FIGURES

Although the characteristic features of this invention will be particularly pointed out in the claims, the invention itself, and the manner in which it may be made and used, may be better understood by referring to the following description taken in connection with the accompanying figures forming a part hereof.

FIG. 1 depicts a general schematic diagram showing the function of a solid oxide fuel cell.

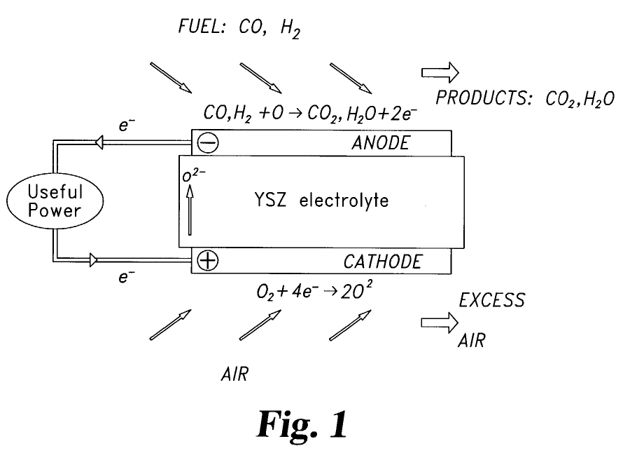

FIG. 2 is a schematic diagram of an embodiment of a fuel cell in accordance with the invention.

FIG. 3 is a schematic diagram of an embodiment of an electrochemical device of the invention.

FIG. 4 depicts a side sectional view of the configuration of a test cell as described in the Examples for use in cathode studies.

FIG. 5 is a plot of % linear shrinkage versus temperature for various modified lanthanum strontium ferrite compositions and unsubstituted lanthanum strontium ferrite cathodes, showing that increasing copper substitution significantly enhances sintering shrinkage characteristics.

FIG. 6 is a plot of % linear shrinkage versus temperature at various strontium levels for lanthanum strontium ferrite cathodes.

FIG. 7 is a plot of % linear shrinkage versus temperature for compositions including various transition metal dopants.

FIG. 8 is a plot of % linear shrinkage versus temperature at various A-site cation deficiency levels.

FIG. 9 is a plot showing long term performance of a Ni/YSZ-YSZ-(La_{0.8}Sr_{0.2})_{0.98}Fe_{0.98}Cu_{0.02}O₃ cell compared to a Ni/YSZ-YSZ-Ce(Sm)O-La_{0.8}Sr_{0.2}FeO₃ cell, showing significantly improved performance with the LSFCu cathode applied directly to the YSZ electrolyte.

FIG. 10 is a plot of % linear shrinkage versus temperature for multiple LSF-20-based compositions, i.e., with and without addition of copper and with and without A-site cation deficiency

### DESCRIPTION OF THE ILLUSTRATED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is hereby intended. Alterations and further modifications in the illustrated devices, and such further applications of the principles of the invention as illustrated herein are contemplated as would normally occur to one skilled in the art to which the invention relates.

The present invention provides novel oxide electrode materials for solid oxide electrochemical devices such as, for example, electrodes for electrolyzers, electrodes for electrochemical sensors and cathodes for solid oxide fuel cells. The invention also provides novel methods for making electrochemical devices and assemblies having electrodes comprising inventive compositions. The invention is described herein primarily by reference to solid oxide fuel cell (SOFC) technology, and a variety of examples are provided herein showing advantageous features and characteristics of the invention in relation to SOFC technology; however, it is not intended that the invention be limited to use in connection with SOFC devices.

It is well known to a person of ordinary skill in the relevant field that a SOFC can have a wide variety of configurations, including, for example and without limitation, a planar (also referred to as “flat plate”) configuration, a tubular configuration and a corrugated configuration. It is to be understood that SOFC cathode materials provided by the present invention can be advantageously used in a wide variety of SOFC configurations, and such are within the scope of the invention.

The present invention is in one respect directed to oxygen reduction electrodes that are suitable for use in an SOFC system. In this regard, subtly modified lanthanum strontium ferrite materials described herein feature excellent electrical performance characteristics (i.e., oxygen reduction kinetics), and also feature robust physical and chemical durability. Furthermore, compositions in accordance with the invention have the added advantage that they feature a sintering temperature of less than about 1100° C. Indeed, many compositions are provided that feature sintering temperatures of less than about 1100° C. The present invention therefore enables the construction of a SOFC system utilizing a relatively low sintering temperature, which has multiple advantages, including, for example, eliminating the need for a ceria layer between the cathode and the YSZ electrolyte, and perhaps enabling the use of steel interconnects in a standard SOFC stack design, which would otherwise not be compatible with a standard SOFC system that is exposed to higher temperatures. Each of these advantages results in the further advantage of substantially reducing manufacturing costs and improving efficiency and reliability of SOFC systems.

Referring now to a preferred embodiment described in the examples, a copper-modified lanthanum strontium ferrite composition is provided for use as a cathode material for a SOFC. A copper-modified lanthanum strontium ferrite cathode (or “air electrode’) composition comprises a perovskite crystal structure that includes copper and optionally one or more other transition metals either as a substitute for iron at the B-site (i.e., as a B-site dopant) or perhaps as a separate phase. While it is not intended that the invention be limited by any theory whereby it achieves its advantageous result, it is believed that the copper is incorporated into the composition by B-site substitution, wherein copper atoms replace iron atoms in the “B-site” of the perovskite crystal structure. The term “substitution” as used herein refers to the presence of a substitute element in the chemical structure of the lanthanum ferrite perovskite. Such substitution is also described in the relevant field using the term “doping.” For ease of description, these terms are used interchangeably herein. The term “copper-modified” is used herein to indicate that a perovskite composition includes copper, irrespective of whether it is included in the perovskite crystal structure as a dopant of is included in the composition as a separate phase. It is also possible that some portion of the copper is incorporated into the material as an oxide in a separate phase, thereby forming a composite including a copper oxide phase and a perovskite structure phase though that has not been observed. It is believed that B-site substitution best describes the manner in which copper is incorporated into lanthanum strontium ferrite; however, it is intended that the invention also encompass materials in which a portion of the copper is present in a separate oxide phase. For purposes of describing the present invention, the term “copper-modified lanthanum strontium ferrite” and related terms are intended to encompass lanthanum strontium ferrite compositions modified by the addition of copper irrespective of the location of the copper in the composition. In other forms of the invention, lanthanum strontium ferrite is modified using a transition metal other than copper.

As will be readily appreciated by a person of ordinary skill in the relevant art, perovskite compositions are typically referred to by the general formula: ABO₃, wherein “A” represents the base element at the A-site of the crystal structure and “B” represents the base element at the B-site of the structure. In lanthanum ferrite compositions as described herein, the base element at the A-site is lanthanum and the base element at the B-site is iron, and thus the general formula for a lanthanum ferrite composition is represented by the general formula: LaFeO₃. In addition, perovskite compositions in accordance with the invention include strontium, and perhaps one or more additional or alternative elements, at the A-site of an ABO₃ structure, which is interchangeably referred to as “A-site substitution” or “A-site doping.”

For purposes of describing the invention, the amount of a dopant or other additive (referred to collectively herein as “dopant”) included in an inventive composition is described in terms of atomic percent (at. %), which is designated herein by the variable “x” for A-site dopants and the variable “y” for B-site dopants. The term “atomic percent” as used herein refers to the atomic ratio of a dopant in the composition to total A-site or B-site atoms present in the composition. As described in the Examples, inventive compositions can be made by glycine/nitrate combustion method, or can alternatively be made using other methods as would occur to a person of ordinary skill in the art, such as, for example, by a Pechini method, by a solid state reaction or by a citrate process.

In a preferred embodiment of the invention, as stated above, lanthanum strontium ferrite compositions are provided that also include copper. Alternative compositions in accordance with the invention include a mixture of copper and manganese and/or zinc, or include only manganese, zinc, or a combination thereof.

The crystal structure of a substituted lanthanum strontium ferrite perovskite is represented by the general formula:

La₁₋ₓSrₓFe_{1-y}B_{y}O₃

(referred to herein as “Formula 1”), where each of x and y is a value between zero and one. Indeed, whether or not an additive is ultimately a dopant in the crystal structure or is present as a separate phase in the perovskite material, a formula such as Formula 1 is useful to indicate the relative proportions of elements used as starting materials in a fabrication process. In accordance with the present invention, B in Formula 1 represents copper, manganese, zinc, or a combination of any one or more of copper, manganese and zinc or a combination of copper, manganese or zinc with one or more other dopants. A person of ordinary skill in the art will appreciate that, in a composition in which the B-site dopant is copper alone, the perovskite structure of the composition can be represented by the formula:

La₁₋ₓSrₓFe_{1-y}Cu_{y}O₃

(referred to herein as “Formula 2”). A person of ordinary skill in the art will also understand that the relative amounts of A-site dopant and B-site dopant in a substituted lanthanum strontium ferrite perovskite structure, as with other perovskite structures, is limited by the “solubility” of the selected dopants in the crystal structure. One or both of A and B in a substituted lanthanum ferrite perovskite composition can be a mixture of a plurality of suitable materials. For example, where the perovskite composition includes a mixture of two A-site dopants and a mixture of two B-site dopants, the composition comprises a perovskite crystal structure that can be represented by the general formula:

La_{1-x′-x″}A′_{x′}A″_{x″}Fe_{1-z′-z″}B′_{z′}B″_{z″}O₃

(referred to herein as “Formula 3”), where A′ and A″ are different A-site dopants in the composition and B′ and B″ are different B-site dopants in the composition. In this formula, the sum of x′ and x″ is a value between zero and 1 and the sum of z′ and z″ is a value between zero and one. It is of course not intended that the invention be limited to compositions having one or two A-site and/or B-site dopants. Rather, Formula 3 is provided as a non-limiting example of a composition including multiple A-site and B-site dopants.

The amount of strontium or other A-site dopant, and the amount of copper or other B-site dopant, are selected in accordance with the invention such that the perovskite material has a sintering temperature of less than about 1100° C., more preferably less than about 1000° C. In one embodiment, a strontium dopant is present in the perovskite crystal structure in an amount up to about 50 at. % (wherein “at. %” for strontium, or other A-site dopant, is defined as the atomic ratio of strontium in the composition to the total number of A-site atoms present in the composition). In another embodiment of the invention, strontium is present in an amount up to about 40 at. %. In yet another embodiment, strontium is present in an amount from about 5 at. % to about 40 at. %. In still another preferred embodiment, strontium is present in an amount of from about 15 at. % to about 30 at. %, more preferably about 20 at. %. In other embodiments, magnesium, calcium, barium, praseodymium, neodymium and samarium are used as the A-site dopant for a lanthanum ferrite material, either alone or together with strontium.

In one preferred embodiment of the invention, a copper-substituted lanthanum ferrite composition is provided in which the copper content is from about 1 atomic percent (at. %) to about 5 at. % (wherein “at. %” for copper, or other B-site dopant, is defined as the atomic ratio of copper in the composition to the total number of B-site atoms present in the composition). In another embodiment, the copper content is from about 2 to about 5 at. %. In still another embodiment, the copper content is from about 2 to about 3 at. %.

In one preferred embodiment, strontium dopant is present in the perovskite crystal structure in an amount up to about 50 at. % and copper is present in an amount of from about 1 to about 5 at. %. In another embodiment of the invention, strontium is present in an amount up to about 40 at. % and copper is present in an amount of from about 1 to about 5 at. %. In yet another embodiment, strontium is present in an amount from about 5 to about 40 at. % and copper is present in an amount from about 2 to about 5 at. %. In still another embodiment, strontium is present in an amount from about 15 to about 30 at. % and copper is present in an amount from about 2 to about 3 at. %.

In other embodiments of the invention, modified lanthanum strontium ferrite compositions are provided that are marginally A-site deficient. As will be appreciated by a person of ordinary skill in the art, the term “A-site deficient” refers to a perovskite in which a certain proportion of A-sites are vacant. For example, a lanthanum strontium ferrite composition having A-site deficiency can be represnted by the general formula:

(La₁₋ₓSrₓ)₂Fe_{1-y}Cu_{y}O₃

(referred to herein as “Formula 4”), wherein z represents the percentage of A-sites that are filled (i.e., to determine the percentage of A-sites that are vacant, z is subtracted from 1.00). In one embodiment of the invention, z=0.9 to 1.0. In another embodiment, z=0.95 to 0.99. In yet another embodiment, z=0.98.

In addition to the above, selections of, and relative proportions of, the strontium or other A-site dopant, the amount of copper or other B-site substitute, and the degree of A-site deficiency are preferably determined such that the composition, when sintered adjacent a zirconium-containing material at a temperature less than about 1100° C., more preferably less than about 1000° C., is not significantly altered by migration of zirconium into the inventive material.

A copper-substituted ferrite material can be made in accordance with the invention by glycine/nitrate combustion method from a combination of ingredients, as is well within the purview of a person of ordinary skill in the art. For example, when making a copper-substituted lanthanum strontium ferrite material, nitrates of Cu, La, Sr and a Fe-containing compound can be mixed in predetermined proportions with, for example, glycine and combusted to produce a powder comprising the copper-substituted lanthanum strontium ferrite. The glycine-metal nitrate synthesis process is described in detail in U.S. Pat. No. 5,114,702 issued May 19, 1992 to L. R. Pederson, L. A. Chick, and G. J. Exarhos, entitled “Metal Oxide Ceramic Powders and Method of Making Same”, which is incorporated herein by reference in its entirety. As an alternative to the glycine/nitrate combustion method, it is also contemplated that inventive compositions can be made using a “solid state reaction method” from starting materials in oxide or salt form at high temperature or using the citrate process. As another example, inventive compositions can be made using the Pechini method, as described in U.S. Pat. No. 3,330,697. In this method, oxides and nitrates are complexed in an aqueous solution with citric acid and heated with ethylene glycol. It is, of course, understood that these methods are provided solely as examples of ways to make inventive compositions, and it is not intended that the invention be limited thereby.

A modified lanthanum strontium ferrite material made or selected in accordance with the invention can be formed into a solid oxide fuel cell cathode or an electrode for other types of oxygen reducing electrochemical devices. A copper-substituted ferrite solid oxide fuel cell cathode can be made in accordance with one aspect of the invention by providing an electrolyte substrate and applying to the electrolyte substrate: (1) an anode layer comprising a suitable composition, and (2) a cathode layer selected in accordance with the invention positioned on the side of the electrolyte layer opposite the anode layer. The cathode layer can be applied to the electrolyte layer either before or after the anode layer is applied. A fuel cell made in such a manner is referred to as an “electrolyte-supported” cell. It is also recognized that the cathode layer can provide the support substrate in some manufacturing protocols for making fuel cells according to some designs. In such a protocol, a cathode substrate layer is provided, an electrolyte layer is applied to a cathode substrate, and then an anode layer is applied to the electrolyte/cathode component adjacent the electrolyte layer. Such an embodiment is referred to herein as a “cathode-supported cell.”

In alternative embodiments of the invention, a solid oxide fuel cell can be made by first providing an anode substrate and then applying an electrolyte layer to the anode substrate. A fuel cell made in such a manner is referred to as an “anode-supported” cell. In this manner of making an electrochemical cell, an anode substrate is independently formed, for example, by tape casting, tape calendering or other method that would occur to a person of ordinary skill in the art, and an electrolyte layer is applied to the anode substrate, such as, for example, by painting, spraying, dip coating, spattering or sedimentation, followed by application of a cathode layer over the electrolyte. In other embodiments, particularly in methods for making fuel cells having a tubular construction, a porous inert substrate can be provided upon which each of the cathode, electrolyte and anode layers is sequentially applied.

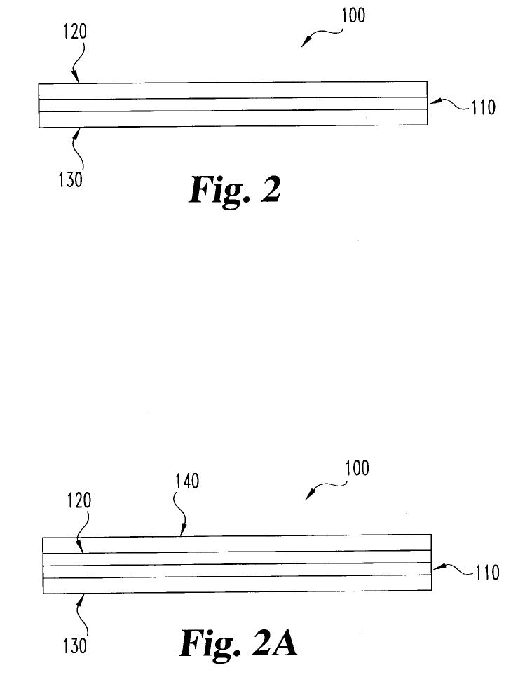

When constructing an electrolyte-supported cell using electrode materials made by the glycine/nitrate combustion method, the SOFC cathode is made by calcining the copper-substituted lanthanum ferrite material to provide a calcined material and mixing the calcined product with a binder to provide a cathode ink. In one embodiment, the calcined material is ground before it is mixed with the binder. For example, the calcined material can be ground to an average particle size of up to about 2 microns. Alternatively, an average particle size of up to about 0.5 microns is used. The grinding can be accomplished by attrition milling. In one embodiment, the grinding is achieved by powder milling the calcined mixture with media at about 500 to about 600 rpm in a 3-roll mill to an average particle size of no greater than about 0.5 microns to provide an intermediate product; drying the intermediate product; and passing the intermediate product through a screen to provide the ground product. The screen can have a mesh size of, for example, from about 200 to about 400 mesh. In a preferred method, the screen has a mesh size of about 325 mesh. The cathode ink is then applied to a solid oxide electrolyte component and sintered to provide a SOFC cathode. As stated above, an anode layer can be applied to the opposite side of the solid oxide electrolyte either before of after application and sintering of the cathode ink. The fuel cell thus has a three-layer configuration as shown schematically in FIG. 2, in which fuel cell 100 includes electrolyte layer 110, anode layer 120 and cathode layer 130.

A wide variety of binders can be selected for use in accordance with the invention to make a cathode ink, many of which are available commercially. In one embodiment of the invention, the binder is a screen-printing binder, such as, for example, BX-18, which is commercially available from Ferro Corporation. When a screen-printing binder is used, the cathode ink can be conveniently applied to a solid oxide electrolyte component by a screen printing process. Screen printing processes, and equipment that can be used therefore, are well known in the art. It is, of course, not intended that the invention be limited to screen-printing applications. In other embodiments, the cathode ink can be applied to a solid oxide electrolyte component by painting, spraying, dip coating, sputtering or sedimentation. In addition, the cathode ink can be provided in a variety of alternative forms, including, for example, as slurries, liquid suspensions, pastes and others.

In one embodiment, a layer of modified lanthanum strontium ferrite material in a fuel cell in accordance with the invention has a thickness of at least 3 microns. In another embodiment, the layer of copper-substituted ferrite material has a thickness of at least about 5 microns. In yet another embodiment, the layer of copper-substituted ferrite material has a thickness of at least about 10 microns. When forming an electrolyte-supported, cathode-supported or inert material-supported cell, the layer of copper-substituted ferrite material can advantageously have a thickness of from about 10 to about 50 microns.

As stated above, one advantage of various inventive compositions is that the cathode layer can be placed into direct contact with a YSZ electrolyte layer or other zirconium-containing material. Prior to the present invention, such direct contact was effectively prohibited due to the unacceptable level of zirconium migration into the cathode during sintering. In accordance with the present invention, a combination of decreased sintering temperatures of the compositions and a zirconium resistance exhibited by inventive formulations provides the ability to place the cathode and electrolyte compositions in direct contact, thus improving the electrical power generation properties of a fuel cell constructed using an inventive cathode material.

In one aspect of the invention, therefore, there is provided an integral solid oxide fuel cell for electrochemically reacting a fuel gas with an oxidant gas to produce a DC output voltage, the fuel cell including a cathode material made or selected in accordance with the invention. The solid oxide fuel cell includes a layer of ceramic ion conducting electrolyte defining first and second opposing surfaces; a conductive anode layer in functional contact with the first surface of the electrolyte layer; and a conductive cathode layer in direct contact with the second surface of the electrolyte layer. In certain preferred embodiments, the electrolyte layer comprises yttria stabilized zirconia (YSZ). The cathode layer comprises a modified lanthanum strontium ferrite material selected in accordance with the present invention. In one embodiment, the modified lanthanum strontium ferrite material forms essentially the entire cathode layer.

In other embodiments, the cathode can include a combination of an inventive modified lanthanum strontium ferrite material and another material, such as, for example, an additional conducting material or the like. In one embodiment, the respective materials are formed into discreet sublayers to form the layer. For example, they can be formed by placing a sublayer of modified lanthanum strontium ferrite material adjacent a solid oxide electrolyte and then forming a second sublayer of a second material over the copper-substituted ferrite cathode material. In another embodiment, the cathode layer comprises a substantially homogenous mixture of a modified lanthanum strontium ferrite material made or selected in accordance with the invention and a finely-divided form of another material, such as, for example, a conductive material.

In one embodiment, the modified lanthanum strontium ferrite material comprises at least about 75% of the cathode, measured by thickness, by volume percent or by mass percent. In another embodiment, the modified lanthanum strontium ferrite material comprises at least about 50% of the cathode. In yet another embodiment, the modified lanthanum strontium ferrite material comprises at least about 25% of the cathode.

The fuel cell having a cathode comprising a modified lanthanum strontium ferrite material selected in accordance with the invention can have a wide variety of configurations, including, for example and without limitation, a planar fuel cell, a tubular fuel cell or a corrugated fuel cell. As a person of ordinary skill in the art will appreciate, with respect to planar SOFC designs, multiple electrochemical cells are typically positioned adjacent one another in series to form a stack. For example, planar solid oxide fuel cell stacks typically comprise a plurality of stacked cathode-electrode-anode-interconnect repeat units with an electrical interconnect between the cathode and the anode of adjacent cells. A representative example of a cathode-electrode-anode-interconnect unit is set forth schematically in FIG. 2A, wherein interconnect 140 is positioned adjacent anode 120. The fuel cell assembly can also include ducts or manifolding to conduct the fuel and oxidant into and out of the stack. Channels for gas flow, either in a cross-flow or a co-flow or a counterflow configuration, are usually incorporated into the cathode, anode and/or interconnect. Further information pertaining to various configurations that can advantageously be used in connection with the present invention is provided in copending U.S. patent application filed Apr. 26, 2002 entitled MULTI-LAYER SEAL FOR ELECTROCHEMICAL DEVICES, which is hereby incorporated herein by reference in its entirety.

With respect to tubular SOFC designs, conventional tubular SOFCs typically include an interior ceramic air electrode in the form of a porous tube. Some tubular SOFC designs also include a porous support tube on the interior of the cathode, which provides structural support for the tubular fuel cell, and also provides a substrate upon which other layers of the cell can be deposited during cell fabrication. The outer surface of the air electrode is mostly covered by a solid electrolyte material, typically made of YSZ. The outer surface of the solid electrolyte is covered by a cermet fuel electrode. In use of a tubular SOFC device, air or oxygen is caused to flow through the center of the tube and a gaseous fuel is caused to contact the anode on the outside of the tube.

It is, of course, understood that there are many design possibilities for fuel cells within these and other categories. Examples of different configurations are provided, for example, in U.S. Pat. No. 5,993,986 to Wallin et al., U.S. Pat. No. 6,106,967 to Virkar et al., U.S. Pat. No. 5,238,754 to Yasuo et al., U.S. Pat. No. 4,997,726 to Akiyama et al., U.S. Pat. No. 4,761,349 to McPheeters et al., U.S. Pat. No. 5,827,620 to Kendall, U.S. Pat. No. 6,248,468 to Ruka et al., U.S. Pat. No. 5,258,240 to Di Croce et al., U.S. Pat. No. 5,932,146 to Kuo et al. and U.S. Pat. No. 4,849,254 to Spengler et al., each of which is hereby incorporated by reference herein. It is, of course, not intended that the invention be limited to these exemplary configurations. The present invention contemplates the use of inventive cathode materials in all such fuel cell configurations now known or later developed, without limitation to particulars of the design. In a preferred embodiment, the fuel cell is a planar fuel cell.

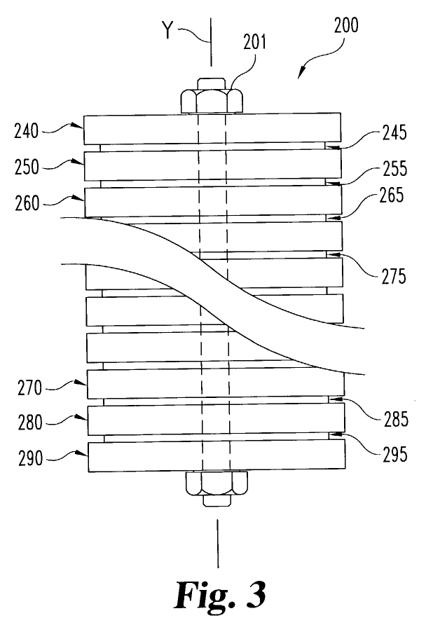

In one aspect of the invention, depicted schematically in FIG. 3, an inventive fuel cell is incorporated in a fuel cell assembly 200 that includes a plurality of solid oxide fuel cells 240, 250, 260, 270, 280, 290. The individual cells are separated by seals 245, 255, 265, 275, 285, 295 and potentially one or more additional structures (not shown), such as, for example, conductive interconnects, gas flow components and the like. One form of the invention, therefore, is a solid oxide fuel cell assembly for electrochemically reacting a fuel gas with a flowing oxidant gas at an elevated temperature to produce a DC output voltage, the assembly including a plurality of integral fuel cell units 240, 250, 260, 270, 280, 290, wherein each unit comprises a layer of ceramic ion conducting electrolyte disposed between and in contact with a conductive anode layer and a conductive cathode layer as described above, and wherein at least one unit includes a conductive cathode layer comprising an inventive cathode material as described herein. The assembly also preferably includes a system for passing a gaseous fuel in contact with said anode layers and passing an oxidizing gas in contact with said cathode layers (not shown); and a system for utilizing electrical energy produced by said fuel cells (not shown).

In view of the advantageous features of modified lanthanum strontium ferrite compositions described herein, the present invention enables the construction of a SOFC system having fuel cell units that can advantageously be operated at a temperature of less than 1000° C., preferably a temperature of about 750° C., and produce a power density of greater than 1.0 W/cm². In certain embodiments, fuel cell units featuring power densities of about 1.6-1.8 W/cm² at 750° C. have been observed. Furthermore, the present invention enables the construction and use of an excellent SOFC that includes metallic components, such as, for example metallic interconnects, and thus feature multiple advantages over prior SOFC systems. A SOFC system can also be constructed utilizing the present invention that includes components made of other materials having advantageous properties that were not heretofore available due to the high temperatures at which prior SOFC systems were fabricated and operated.

Reference will now be made to specific examples illustrating various preferred embodiments of the invention as described above. It is to be understood, however, that the examples are provided to illustrate preferred embodiments and that no limitation to the scope of the invention is intended thereby.

### EXAMPLE ONE

### General Experimental Set-up

For use in the experiments reported below, substituted lanthanum ferrite powders were prepared from mixed nitrate solutions by a glycine/nitrate combustion process using La, Sr, Cu, and Fe nitrate stock solutions mixed according to the desired final stoichiometry. For La and Sr solutions the concentrations were established by gravimetric analysis. The Fe- and Cu-nitrate solution concentrations were established from dissolving a known mass of elemental Fe or Cu into a known mass of nitric acid. Glycine was added at half of the stoichiometric amount. The glycine-nitrate mixtures were then combusted and the ash was calcined at 800° C., sieved and then further calcined at from 800-1100° C. for 2-4 hours.

Cathode compositions of the type (La_{1-z}Sr_{z})ₓFe_{1-y}Cu_{y}O₃ (x=0.9-1.0, y=0.01-0.05, z=0.15-0.3) and (La_{0.8}Sr_{0.2})_{0.98}Fe_{0.98}M_{0.02}O₃ (where M=Mn or Zn) were synthesized. An un-doped lanthanum ferrite (LaFeO₃) material is an ABO₃ perovskite in which La³⁺ cations occupy the perovskite structure A-site, Fe³⁺ cations occupy the perovskite B-site, and the ratio of A/B cations=1. To understand the chemical formula of the compositions investigated consider (La_{0.8}Sr_{0.2})_{0.98}Fe_{0.98}Cu_{0.02}O₃ as an example. The designation indicates (1) an A/B cation ratio of 0.98, (2) 20 mol. % of La is replaced by 20 mol. % of Sr, and (3) 2 mol. % of Fe is replaced by 2 mol. % of Cu.

Phase analysis of each cathode composition was analyzed by a room temperature X-ray powder diffraction method using a Philips Wide-Range Vertical Goniometer and a Philips XRG3 100 X-ray Generator. Powders were sieved through-325 mesh screen, pressed onto single-crystal quartz slides, and data recorded from 20-80° 2Θ with a 0.02-0.04° step size and 1-2 second count time. A single-phase cubic perovskite structure similar to un-substituted lanthanum strontium ferrite (LaFeO₃) was observed for all compounds; however, the presence of separate phases cannot be ruled out due to the 3-5 wt. % detection limit inherent of the X-ray powder diffraction technique.

Cathode powders (calcined at 800° C.) were pressed into bars (20 mm×10 mm×5 mm) uniaxially at 33 MPa and then isostatically at 130 MPa prior to sintering shrinkage analysis. Sintering shrinkage tests were carried out on cathode powders in a Unitherm Model 1161 vertical pushrod dilatometer with a 40 g load from room temperature to 1200° C. at a heating rate of 3° C./min.

Next, the powders were attrition milled to reduce the average particle size to less than 1 μm. The attrition milling procedure included powder milling with media for 5 minutes at 550 rpm, sampling and checking the particle size. If the average particle size was larger than desired, the powder was attrition milled until the desired particle size was reached. After that, the powder was removed from the mill, dried, and passed through a 325 mesh screen. Cathode inks for screen-printing were produced by combining 50-60% oxide powder (pre-mixed with carbon black to add additional porosity in the post-fired cathode) and 40-50% commercial organic binder by weight, which were then mixed using an Exakt 11671 three-roll mill. The inks were screen-printed onto the anode-YSZ electrolyte substrates (fabrication of substrate detailed below) and sintered from 925-1000° C. to provide porous electrodes having a thickness of about 30-60 microns.

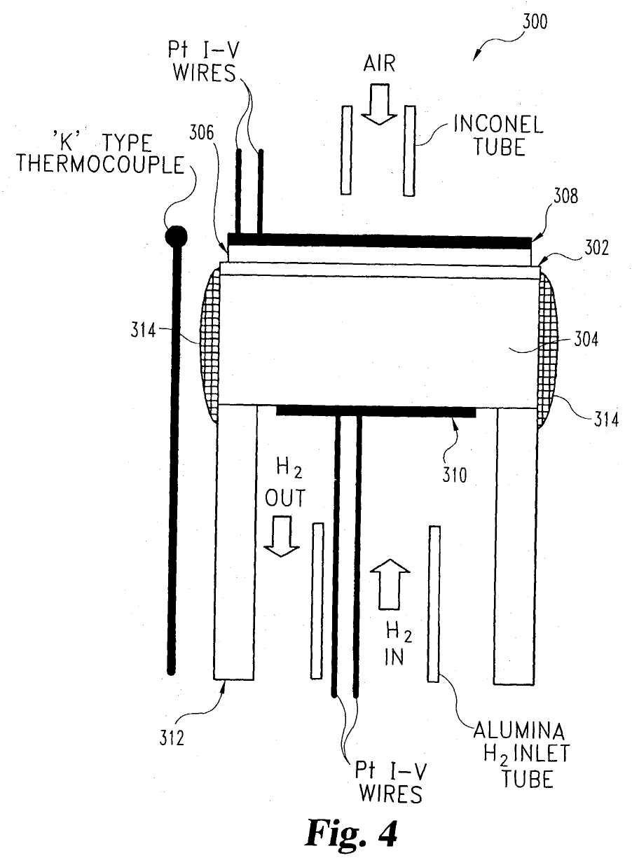

Anode (NiO-YSZ)-electrolyte (YSZ) substrate samples were produced via standard organic tape-casting and tape lamination procedures, co-sintered at 1375° C. for 1 hour, and subsequently creep-flattened at 1350° C. for 2 hours. The post-sintered/post-reduced anode (˜500 μm thick) was comprised of a bulk layer with a solids ratio of 40/60 vol. % Ni/YSZ (and approximately 30 vol. % porosity), and a 5-10 μm thick active anode layer with 50/50 solids vol. % Ni/YSZ. A schematic diagram of a representative single test cell 300 is depicted in FIG. 4. The sintered thickness of the YSZ membrane 302 was 5-10 μm thick. The diameter of the anode support 304 was 25 mm, and that of the screen-printed cathode 306 was 19.5 mm. The cathode area was used as the active cell area to calculate current and power densities. Screen-printed Pt grids with embedded Pt gauze, and screen-printed NiO grids with embedded Ni gauze were used as current collectors 308, 310 for the cathode 306 and anode 304, respectively. The cells were sealed to an alumina outer tube 312 using Aremco cements 314, and current-voltage data recorded at 750° C. using an Arbin BT2000 potentiostat-galvanostat electrochemical testing system (not shown). Cells were held at 0.7 V and periodically subjected to current sweeps from 0-7 A. 97% H₂-3% H₂O was flowed to the anode at 200 sccm, and air to the cathode at 300 sccm.

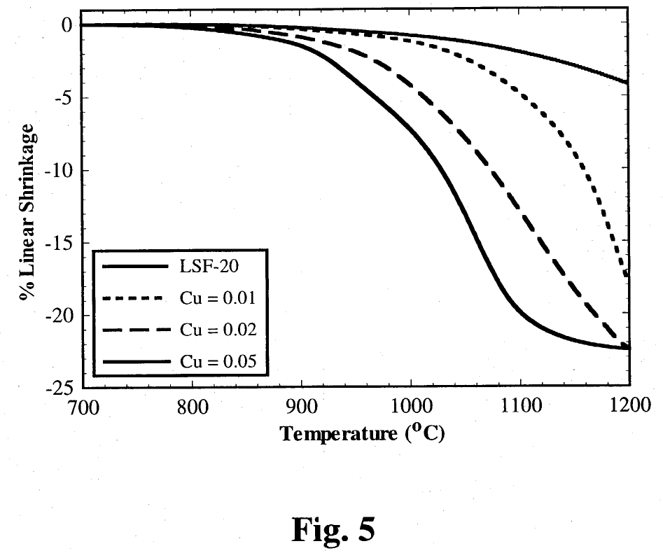

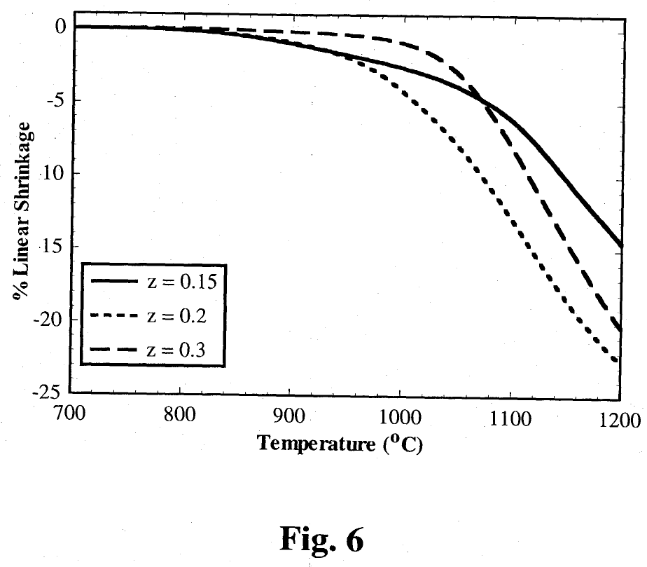

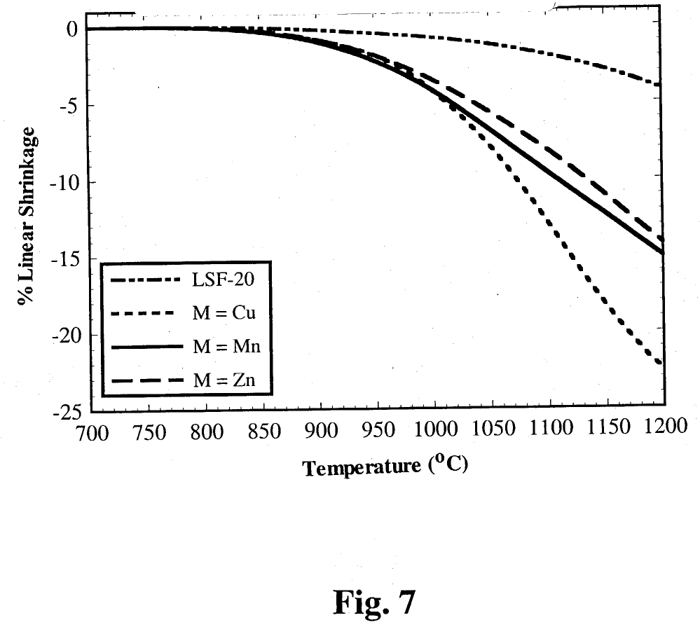

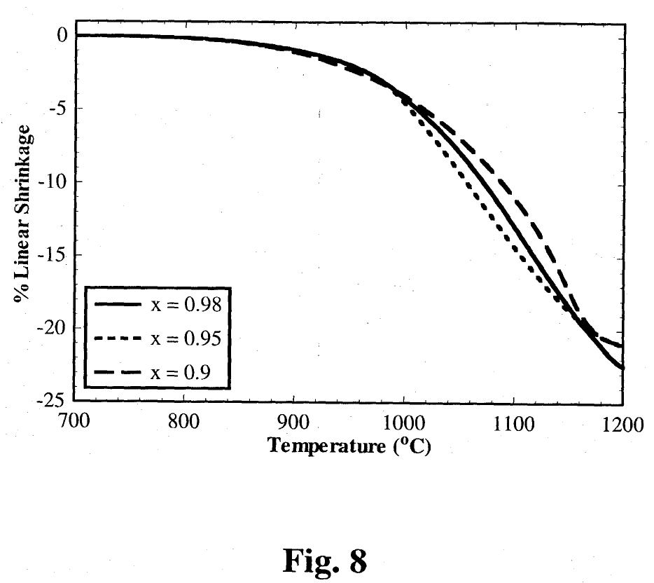

FIGS. 5-8 are plots of % linear shrinkage versus temperature for various modified lanthanum strontium ferrite compositions and unmodified lanthanum strontium ferrite cathodes. FIG. 5 displays the effect of various Cu-dopant levels on the sintering characteristics of (La_{0.8}Sr_{0.2})_{0.98}Fe_{1-y}Cu_{y}O₃ (y=0.01, 0.02 and 0.05) compositions compared to La_{0.8}Sr_{0.2}FeO₃ (LSF-20), showing that increasing the Cu-dopant enhances the sintering shrinkage characteristics. FIG. 6 displays the effect of various Sr levels on the sintering characteristics of (La_{0.8}Sr_{0.2})_{0.98}Fe_{0.98}Cu_{0.02}O₃ (z=0.15, 0.2 and 0.3) compositions. FIG. 7 displays the effect of various transition metal dopants on the sintering characteristics of (La_{0.8}Sr_{0.2})_{0.98}Fe_{0.98}M_{0.02}O₃ compositions compared to La_{0.8}Sr_{0.2}FeO₃ (LSF-20) and (La_{0.8}Sr_{0.2})_{0.98}FeO₃, showing that Cu, Mn and Zn dopants offer the greatest sintering enhancement over LSF-20. FIG. 8 displays the effect of various A-site cation deficiency levels on the sintering characteristics of (La_{0.8}Sr_{0.2})ₓFe_{0.98}Cu_{0.02}O₃ (x=0.98, 0.95 and 0.9) compositions, showing that a wide range of A-site deficiency levels can be used in inventive cathodes.

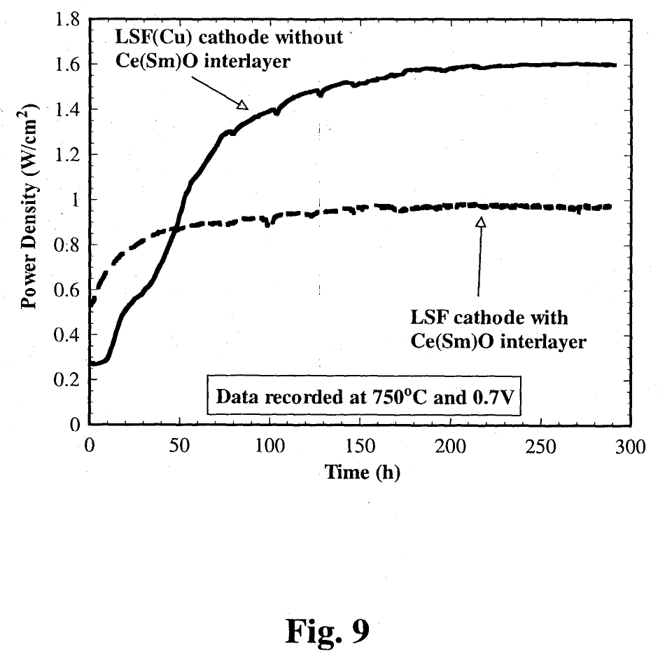

FIG. 9 presents performances of a test fuel cell with a nickel-zirconia anode, a YSZ electrolyte and an inventive cathode, compared to a fuel cell with a standard LSF-20 cathode separated from the electrolyte by a ceria layer. Data was recorded at 750° C. and 0.7 Volt. It is seen that the cell with the inventive cathode yields a power density of about 1.6 W/cm² at 750° C. All other factors being equal, the cell with the ceria/LSF-20 cathode yields a current density of about 0.9 W/cm². Cells using the new materials show approximately two times the power density compared to cells using ceria/LSF-20 cathodes. No degradation in performance of cells with inventive cathodes was traced over the tested time of 300 hours.

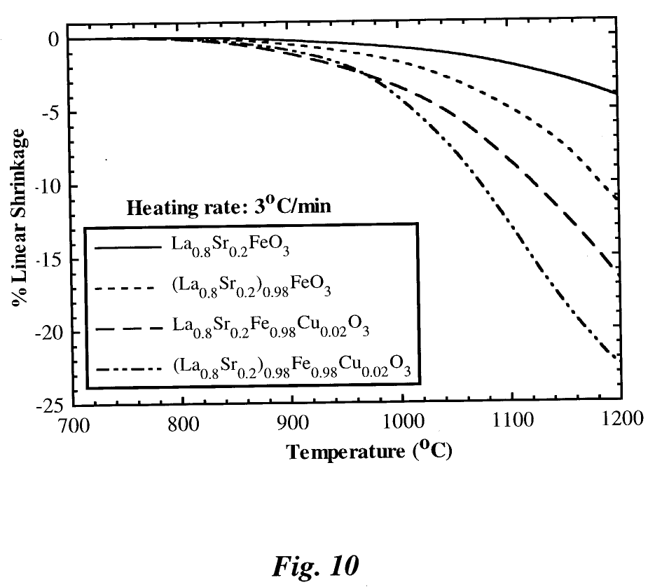

FIG. 10 displays the sintering characteristics of LSF-20, with and without addition of copper and with and without A-site cation deficiency, showing that the combination of copper and A-site deficiency produced the best sintering characteristics of the compositions shown.

### CLOSURE

While the invention has been illustrated and described in detail in the drawings and foregoing description, the same is to be considered as illustrative and not restrictive in character. Only certain embodiments have been shown and described, and all changes, equivalents, and modifications that come within the spirit of the invention described herein are desired to be protected. Any experiments, experimental examples, or experimental results provided herein are intended to be illustrative of the present invention and should not be considered limiting or restrictive with regard to the invention scope. Further, any theory, mechanism of operation, proof, or finding stated herein is meant to further enhance understanding of the present invention and is not intended to limit the present invention in any way to such theory, mechanism of operation, proof, or finding. Thus, the specifics of this description and the attached drawings should not be interpreted to limit the scope of this invention to the specifics thereof. Rather, the scope of this invention should be evaluated with reference to the claims appended hereto. In reading the claims it is intended that when words such as “a”, “an”, “at least one”, and “at least a portion” are used there is no intention to limit the claims to only one item unless specifically stated to the contrary in the claims. Further, when the language “at least a portion” and/or “a portion” is used, the claims may include a portion and/or the entire items unless specifically stated to the contrary. Finally, all publications, patents, and patent applications cited in this specification are herein incorporated by reference to the extent not inconsistent with the present disclosure as if each were specifically and individually indicated to be incorporated by reference and set forth in its entirety herein.

What is claimed is:

1. A solid oxide fuel cell for electrochemically reacting a fuel gas with an oxidant gas to produce a DC output voltage, said solid oxide fuel cell comprising:
a layer of ceramic ion conducting electrolyte defining first and second opposing surfaces, said electrolyte comprising a zirconium-containing material;
a conductive anode positioned in contact with the first surface of said electrolyte layer; and
a conductive cathode positioned in contact with the second surface of said electrolyte layer, said cathode comprising a modified lanthanum ferrite perovskite material;
wherein said modified lanthanum ferrite perovskite material is in direct contact with said zirconium-containing material; and
wherein said fuel cell has a power density of at least about 1.0 W/cm² at 750° C. and 0.7V.

2. The fuel cell in accordance with claim 1 wherein copper is present in the perovskite material in an amount of from about 1 to about 5 atomic percent.

3. The fuel cell in accordance with claim 1 wherein said copper is present in the perovskite material in an amount of from about 2 to about 5 atomic percent.

4. The fuel cell in accordance with claim 1 wherein strontium is present as an A-site dopant in the perovskite material in an amount up to about 50 atomic percent.

5. The fuel cell in accordance with claim 1 wherein strontium is present as an A-site dopant in the perovskite material in an amount of from about 5 to about 40 atomic percent.

6. The fuel cell in accordance with claim 1 wherein the perovskite material comprises A-site deficiency of from about 0.9 to about 1.0.

7. The fuel cell in accordance with claim 1 wherein the perovskite material comprises A-site deficiency of from about 0.95 to about 0.99.

8. The fuel cell in accordance with claim 1 wherein the perovskite material comprises A-site deficiency of about 0.98.

9. The fuel cell in accordance with claim 1 wherein the perovskite material includes an A-site dopant selected from the group consisting of Mg, Ca, Sr, Ba, Pr, Nd, Sm and combinations thereof.

10. The fuel cell in accordance with claim 5 wherein the strontium is present in the perovskite material in an amount of from about 5 atomic percent to about 40 atomic percent and copper is present in the perovskite material in an amount of from about 1 atomic percent to about 5 atomic percent.

11. The fuel cell in accordance with claim 5 wherein the strontium is present in the perovskite material in an amount of from about 15 atomic percent to about 30 atomic percent and copper is present in the perovskite material in an amount of from about 2 atomic percent to about 5 atomic percent.

12. The fuel cell in accordance with claim 5 wherein the perovskite material further comprises at least one B-site dopant selected from the group consisting of manganese and zinc.

13. The fuel cell in accordance with claim 1 wherein the perovskite material has a sintering temperature of no greater than about 1100° C.

14. The fuel cell in accordance with claim 1 wherein the perovskite material comprises a layer having a thickness of from about 1 to about 50 microns.

15. The fuel cell in accordance with claim 1 wherein the perovskite material comprises a layer having a thickness of from about 1 to about 30 microns.

16. The fuel cell in accordance with claim 1 wherein the perovskite material comprises essentially the entire cathode layer.

17. The fuel cell in accordance with claim 1 wherein the perovskite material comprises at least about 25% of said cathode layer.

18. The fuel cell in accordance with claim 1 wherein said cathode layer comprises a substantially homogenous mixture of the perovskite material and a finely-divided form of a second material.

19. The fuel cell in accordance with claim 1 wherein said cathode layer comprises a perovskite composition having the formula:
La₁₋ₓ₋ₓ′ SrₓA′_{x′}Fe_{1-y-y′}Cu_{y}B′_{y′}O₃
wherein x is from about 0.05 to about 0.4; y is from about 0.01 to about 0.05; x′ is from 0 to about 0.4; and y′ is from 0 to about 0.4.

20. The fuel cell in accordance with claim 1 wherein said cathode layer comprises a perovskite composition having the formula:
La_{0.8} Sr_{0.2} Fe_{0.98} Cu_{0.02} O₃

21. The fuel cell in accordance with claim 1 wherein said cathode layer comprises a perovskite composition having the formula:
(La_{0.8} Sr_{0.2})_{0.98} Fe_{0.98} CU_{0.02} O₃

22. The fuel cell in accordance with claim 1, further comprising at least one metallic interconnect.

23. A solid oxide fuel cell for electrochemically reacting a fuel gas with an oxidant gas to produce a DC output voltage, said solid oxide fuel cell comprising:
a layer of ceramic ion conducting electrolyte defining first and second opposing surfaces;
a conductive anode positioned adjacent the first surface of said electrolyte layer; and
a conductive cathode positioned adjacent the second surface of said electrolyte layer, said cathode comprising a lanthanum ferrite perovskite material;
wherein copper is present in the lanthanum ferrite perovskite material in an amount of from about 1 to about 5 atomic percent; and
wherein the lanthanum ferrite perovskite material has a sintering temperature of no greater than about 1100° C.

24. The fuel cell in accordance with claim 23 wherein said lanthanum ferrite perovskite material is in direct contact with said electrolyte.

25. A solid oxide fuel cell assembly for electrochemically reacting a fuel gas with a flowing oxidant gas to produce a DC output voltage, said assembly comprising a plurality of integral fuel cell units, each unit comprising a layer of ceramic ion conducting electrolyte disposed between a conductive anode layer and a conductive cathode layer;
wherein said electrolyte of at least one of said fuel cells comprises a zirconium-containing material;
wherein said cathode layer of at least one of said fuel cells comprises a modified lanthanum ferrite composition;
wherein said modified lanthanum ferrite composition is in direct contact with said zirconium-containing material; and
wherein said at least one of said fuel cells has a power density of at least about 1.0 W/cm² at 750° C. and 0.7V.

26. The fuel cell assembly in accordance with claim 25 wherein copper is present in the composition in an amount of from about 1 to about 5 atomic percent.

27. The fuel cell assembly in accordance with claim 25 wherein said copper is present in the composition in an amount of from about 2 to about 5 atomic percent.

28. The fuel cell assembly in accordance with claim 25 wherein strontium is present as an A-site dopant in the perovskite material in an amount up to about 50 atomic percent.

29. The fuel cell assembly in accordance with claim 25 wherein strontium is present as an A-site dopant in the perovskite material in an amount of from about 5 to about 40 atomic percent.

30. The fuel cell assembly in accordance with claim 25 wherein the composition comprises A-site deficiency of from about 0.9 to about 1.0.

31. The fuel cell assembly in accordance with claim 25 wherein the composition comprises A-site deficiency of from about 0.95 to about 0.99.

32. The fuel cell assembly in accordance with claim 25 wherein the composition comprises A-site deficiency of about 0.98.

33. The fuel cell assembly in accordance with claim 25 wherein the composition includes an A-site dopant selected from the group consisting of Mg, Ca, Sr, Ba, Pr, Nd, Sm and combinations thereof.

34. The fuel cell assembly in accordance with claim 25 wherein strontium is present as an A-site dopant in the composition in an amount of from about 5 atomic percent to about 40 atomic percent and copper is present in the composition in an amount of from about 1 atomic percent to about 5 atomic percent.

35. The fuel cell assembly in accordance with claim 25 wherein strontium is present as an A-site dopant in the composition in an amount of from about 15 atomic percent to about 30 atomic percent and copper is present in the composition in an amount of from about 2 atomic percent to about 5 atomic percent.

36. The fuel cell assembly in accordance with claim 25 wherein the composition further comprises at least one B-site dopant selected from the group consisting of manganese and zinc.

37. The fuel cell assembly in accordance with claim 25 wherein said at least one of said fuel cells has a power density of at least about 1.0 W/cm² at 750° C. and 0.7V.

38. The fuel cell assembly in accordance with claim 25 wherein said cathode layer comprises a perovskite composition having the formula:
La_{1-x-x′}SrₓA′_{x′}Fe_{1-y-y′}Cu_{y}B′_{y′}O₃
wherein x is from about 0.05 to about 0.4; y is from about 0.01 to about 0.05; x′ is from 0 to about 0.4; and y′ is from 0 to about 0.4.

39. The fuel cell assembly in accordance with claim 25 wherein said cathode layer comprises a perovskite composition having the formula:
La_{0.8} Sr_{0.2} Fe_{0.98} Cu_{0.02} O₃

40. The fuel cell assembly in accordance with claim 25 wherein said cathode layer comprises a perovskite composition having the formula:
(La_{0.8} Sr_{0.2})_{0.98} Fe_{0.98} Cu_{0.02} O₃

41. The fuel cell assembly in accordance with claim 25, further comprising:
a system for passing a gaseous fuel in contact with said anode layers and passing an oxidizing gas in contact with said cathode layers; and
a system for utilizing electrical energy produced by said fuel cells.

42. The fuel cell assembly in accordance with claim 25, further comprising at least one metallic interconnect.

43. A solid oxide fuel cell assembly for electrochemically reacting a fuel gas with a flowing oxidant gas to produce a DC output voltage, said assembly comprising a plurality of integral fuel cell units, each unit comprising a layer of ceramic ion conducting electrolyte disposed between a conductive anode layer and a conductive cathode layer;
wherein said cathode layer of at least one of said fuel cells comprises a lanthanum ferrite composition;
wherein copper is present in the lanthanum ferrite perovskite material in an amount of from about 1 to about 5 atomic percent; and
wherein the lanthanum ferrite perovskite composition has a sintering temperature of no greater than about 1100° C.

44. The fuel cell assembly in accordance with claim 43 wherein said lanthanum ferrite composition is in direct contact with said electrolyte.

45. A cathode for a solid oxide fuel cell, the cathode comprising a modified lanthanum ferrite perovskite material; the material including a member selected from the group consisting of copper, manganese and zinc in an amount of from about 1 to about 5 atomic percent.

46. The cathode in accordance with claim 45 wherein copper is present in the perovskite in an amount of from about 2 to about 3 atomic percent.

47. The cathode in accordance with claim 45 wherein the material includes an A-site dopant selected from the group consisting of Mg, Ca, Sr, Ba, Pr, Nd, Sm and combinations thereof.

48. The cathode in accordance with claim 45 wherein strontium is present as an A-site dopant in the material in an amount of from about 5 atomic percent to about 40 atomic percent and copper is present in the copper-substituted lanthanum ferrite material in an amount of from about 1 atomic percent to about 5 atomic percent.

49. The cathode in accordance with claim 45 wherein strontium is present as an A-site dopant in the material in an amount of from about 15 atomic percent to about 30 atomic percent and copper is present in the copper-substituted lanthanum ferrite material in an amount of from about 2 atomic percent to about 5 atomic percent.

50. The cathode in accordance with claim 45 wherein the material comprises copper in an amount of from about 2 to about 3 atomic percent.

51. The cathode in accordance with claim 45 wherein the material comprises A-site deficiency of from about 0.9 to about 1.0.

52. The cathode in accordance with claim 45 wherein the material comprises A-site deficiency of from about 0.95 to about 0.99.

53. The cathode in accordance with claim 45 wherein the material comprises A-site deficiency of about 0.98.

54. The cathode in accordance with claim 45 wherein the copper-substituted ferrite material is in direct contact with an electrolyte layer comprising a zirconium-containing material.

55. The cathode in accordance with claim 45 wherein said cathode comprises a perovskite composition having the formula:
La_{1-x-x′} SrₓA′_{x″}Fe_{1-y-y′}Cu_{y}B′_{y} O₃
wherein x is from about 0.05 to about 0.4; y is from about 0.01 to about 0.05; x′ is from 0 to about 0.4; and y′ is from 0 to about 0.4.

56. The cathode in accordance with claim 45 wherein said cathode comprises a perovskite composition having the formula:
La_{0.8} Sr_{0.2} Fe_{0.98} Cu_{0.02} O₃

57. The cathode in accordance with claim 45 wherein said cathode comprises a perovskite composition having the formula:
(La_{0.8} Sr_{0.2})_{0.98} Fe_{0.98} Cu_{0.02} O₃

58. The cathode in accordance with claim 45 wherein the perovskite material has a sintering temperature of no greater than about 1100° C.

59. An oxygen reduction electrode for an electrochemical device, the electrode comprising a modified lanthanum ferrite perovskite material; the material including a member selected from the group consisting of copper, manganese and zinc in an amount of from about 1 to about 5 atomic percent.

60. The electrode in accordance with claim 59 wherein the electrochemical device is selected from the group consisting of a solid oxide fuel cell, an electrolyzer, an electrochemical pump and an electrochemical sensor.

61. The electrode in accordance with claim 59 wherein said electrode comprises a perovskite composition having the formula:
La₁₋ₓ SrₓFe_{1-y}Cu_{y} O₃
wherein x is from about 0.15 to about 0.3; and wherein y is from about 0.01 to about 0.05.

62. A method for producing electrical energy, comprising:
providing a solid oxide fuel cell, the solid oxide fuel cell including a layer of ceramic ion conducting electrolyte defining first and second opposing surfaces, said electrolyte comprising a zirconium-containing material; a conductive anode positioned at the first surface of said electrolyte layer; and a conductive cathode positioned at the second surface of said electrolyte layer, said cathode comprising a modified lanthanum ferrite perovskite material; wherein said modified lanthanum ferrite perovskite material is in direct contact with said zirconium-containing material; and wherein said fuel cell has a power density of at least about 1.0 W/cm² at 750° C. and 0.7V;
causing air or other oxidizing gas to flow in contact with the cathode layer; and
causing a fuel gas to flow in contact with the anode layer to provide electrical energy.

63. The method in accordance with claim 62 wherein copper is present in the material in an amount of from about 1 to about 5 atomic percent.

64. The method in accordance with claim 62 wherein the material comprises A-site deficiency of from about 0.95 to about 0.99.

65. The method in accordance with claim 62, further comprising operating the fuel cell at a temperature of no greater than about 1100° C.

66. The method in accordance with claim 62, further comprising operating the fuel cell at a temperature of about 750° C.

67. The method in accordance with claim 62 wherein the solid oxide fuel cell further comprises at least one metallic interconnect.

68. A method for making an oxygen reduction electrode for an electrochemical device comprising:
providing a green material comprising a modified lanthanum ferrite perovskite composition including a member selected from the group consisting of copper, manganese and zinc in an amount of from about 1 to about 5 atomic percent;
placing the green material in contact with an electrolyte layer; and
sintering the green material at a temperature of no greater than about 1100° C.

69. The method in accordance with claim 68 wherein copper is present in the copper-substituted ferrite material in an amount of from about 2 to about 5 atomic percent.

70. The method in accordance with claim 68 wherein the material comprises A-site deficiency of from about 0.95 to about 0.99.

71. The method in accordance with claim 68 wherein the electrolyte layer is a zirconium-containing electrolyte layer; and where the lanthanum ferrite composition is in direct contact with the zirconium-containing electrolye layer.

72. The method in accordance with claim 68 wherein the electrochemical device is selected from the group consisting of a solid oxide fuel cell, an electrolyzer, an electrochemical pump and an electrochemical sensor.

73. The method in accordance with claim 68 wherein strontium is present in the material in an amount of from about 5 to about 40 atomic percent.

74. The method in accordance with claim 68 wherein strontium is present in the material in an amount of from about 15 to about 30 atomic percent.

75. The method in accordance with claim 68 wherein said electrode comprises a perovskite composition having the formula:
La_{0.8} Sr_{0.2} Fe_{0.98} Cu_{0.02} O₃

76. The method in accordance with claim 68 wherein said electrode comprises a perovskite composition having the formula:
(La_{0.8} Sr_{0.2})_{0.98} Fe_{0.98} Cu_{0.02} O₃
